(19) United States
(12) Patent Application Publication
(10) Pub. No.: US 2004/0251640 A1
(43) Pub. Date: Dec. 16, 2004

(54) Chuck device

(75) Inventor: Hans-Werner Fuchs, Ostermiething (AT)

Correspondence Address: KLARQUIST SPARKMAN, LLP, 121 SW SALMON STREET, SUITE 1600, PORTLAND, OR, 97204, US

(73) Assignee: W&H Dentalwerk Burmoos GmbH

(21) Appl. No.: 10/862,967

(22) Filed: Jun. 7, 2004

(30) Foreign Application Priority Data
Jun. 12, 2003 (AT) A 909/2003

(51) Int. Cl. B23B 31/12

(52) U.S. Cl. 279/46.1

(57) ABSTRACT

The invention concerns a chuck device for use in medical, in particular in dental, straight and contra angle handpieces for accepting removable treatment tools by means of a clamping tab. The clamping tab is immovably connected by at least two points of contact with the casing of the chuck device. The spring effect and the clamping force for clamping the tool are generated and exercised exclusively by the clamping tab. Moreover, a method for manufacturing such a chuck device is described, by which means the complete chuck device may be manufactured on one machine only, exclusively by mechanical processing (machining), preferably by milling.

### CROSS REFERENCE TO RELATED APPLICATION

The present application claims priority from pending Austrian Patent Application No. A 909/2003, filed Jun. 12, 2003, which is incorporated herein by reference.

### BACKGROUND OF THE INVENTION

1. Field

The invention concerns a chuck device for use in medical, particularly in dental, straight and contra angle handpieces for accepting removable treatment tools, for example dental drills. In particular, the invention concerns a chuck device that clamps the treatment tool by means of a clamping tab.

2. Description of Prior Art

A prior chuck device is known from the German Patent Publication DE-OS 23 426 80, for example. It discloses a metal inner sleeve, with webs created by the use of slots. This inner sleeve is surrounded by an outer sleeve of an elastic material. At assembly, the two sleeves are fitted together and then placed in the turbine of a handpiece. The diameter of the two sleeves and the bore on the turbine are selected such that when fitting the elastic outer sleeve, and because of the slotted parts on the inner sleeve, they are pressed radially inwards. The diameter of the restriction in the bore of the inner sleeve thus created is smaller than the outside diameter of the tool shaft to be received therein. When the tool shaft is inserted into the clamping sleeve, the restricted section of the metallic inner sleeve is forced outwards, causing the elastic outer sleeve to be compressed and deformed. The spring effect and clamping force holding the tool in the chuck device are generated by the restoring force of the compressed and deformed elastic outer sleeve, transferred to the metallic inner sleeve.

A disadvantage of this prior device is the number of components (inner sleeve, outer sleeve, turbine) from which this chuck device is manufactured, in conjunction with additional manufacturing costs and increased assembly effort.

For a number of years the patent applicant has manufactured a chuck device 1, manufactured from a single piece (FIG. 1, State of the Art). In a first processing step, a central bore 3 for accepting a tool shaft is machined into a metal cylinder (spindle) 2 on a lathe. In a further processing step clamping tabs 4 are manufactured from the spindle 2 using a wire EDM machine, whereby, in accordance with FIG. 1, each clamping tab 4 only remains attached to the casing 5 of the spindle 2 at one point of contact 10. The clamping tabs 4 are subsequently pressed inwards slightly (into the bore 3). In this case, the spring effect and clamping force for clamping the tool are generated exclusively by the inward pressure of the clamping tabs 4. A turbine, propelled by means of compressed air, and which sets the chuck device 1 and the tool rotating, can be fitted directly to the spindle 2, so that the chuck device 1 consists of a single component.

A disadvantage of this chuck device is the time-consuming and expensive production, for which two machines (lathe and EDM machine) are required, and in particular the very expensive EDM process. The EDM process is necessary because the slot 6, by which means the clamping tabs 4 are manufactured, does not have a uniform width but has an enlarged end section 11. This serves to hinder crack formation in the casing 5 of the spindle 2 when bending the tabs 4 radially into the bore 3, which would render the spindle useless or substantially reduce its useful lifetime.

There is, therefore, a need for an innovative, reliable chuck device made with reduced manufacturing and assembly effort.

### SUMMARY OF THE INVENTION

This aim is achieved in accordance with the chuck device presented herein and a process for producing such a chuck device as set out herein.

In a chuck device according to an embodiment of the invention, a treatment tool is exclusively held by the spring effect and clamping force generated and exercised by at least one clamping tab. Surprisingly, this can also be achieved with a clamping tab that has an immovable connection with at least two points of contact to the casing of the chuck device. Such a chuck device has the advantage that the manufacture of at least one clamping tab from the casing of the chuck device is carried out exclusively by means of mechanical processing (machining), generally by turning and/or milling, and may be performed on a single machine, and the EDM process is eliminated.

The following steps are preferred for manufacturing the chuck device: First, a central bore is manufactured in a metal cylinder for accepting the tool shaft, so that the cylindrical outer casing of the chuck device results. Slots are manufactured in this cylinder, beginning at the outer casing and radially inwards, and preferably are milled. The section remaining between two respective slots, which has an immovable connection with at least two points of contact to the casing of the chuck device, forms a clamping tab. In a further step, this is pressed radially inwards, so that the clear dimension between the clamping tab, bent inwards, and the opposed inner wall portion of the casing is smaller than the diameter of the tool shaft.

In a preferred embodiment, the wall thickness, at least of the area of the casing in which the clamping tab is manufactured, is less than the remainder of the casing, in order to ease bending inwards of the clamping tab and to increase the spring effect. In a preferred embodiment, the reduction in wall thickness can be carried out before milling the slots, also by milling.

When inserting a treatment tool into the chuck device, the clamping tab is displaced radially outwards by the shaft of the tool. The clamping force required to clamp the tool results from the restoring force of the displaced clamping tab. If the treatment tool is removed from the chuck device, the spring effect of the clamping tab is sufficient to automatically return it to its original position.

In a preferred embodiment, in order to equally guarantee the clamping force required pursuant to EN ISO 7785-1 for the treatment instrument, and the desired spring force, as well as the wear resistance required for frequent drill changing, the clamping tab may be fabricated from a material with a tensile strength of greater than 1,000 MPa and/or a Young's modulus of 110 GPa to 220 GPa, preferably of stainless steel with a Young's modulus of 190 GPa to 220 GPa.

In another embodiment the chuck device is equipped with more than one, preferably with two to four and most preferably with three clamping tabs. This improves the running characteristics of the treatment tool and the clamping force is distributed to several clamping tabs.

In one embodiment, at least one clamping tab has an asymmetrical shape. This deformation is preferably achieved simultaneously with pressing the clamping tabs into the spindle bore. In one particularly preferred embodiment example, the apex (i.e. the point projecting furthest into the interior of the spindle bore) of the curved clamping tab is located in the upper half, specifically at around ⅔ of the total length of the clamping tab, with respect to the orifice on the chuck device through which the tool is inserted into the chuck device. Both inserting the tool and fixing the turbine handpiece during operation are optimised by means of this special shape: When inserting the tool into the chuck device the slope of the clamping tab, and thus the force, is small. If the tool is affixed in the chuck device, on the other hand, it must first overcome the steep slope of the clamping tab in order to be released, for which more force is needed. This further reduces the danger of accidental release, particularly during treatment.

In a further embodiment, the length of the clamping tabs and the slots is less than the height of the turbine. If the turbine is affixed exactly over the clamping tabs and the slots are thus perfectly covered, this hinders entry of soiling, such as saliva, blood or pieces of tissue, via the tool and the chuck device into the interior of the turbine handpiece during treatment.

The user can both insert the drill into the chuck device and release the drill from the chuck device without added aids if necessary. To ease release of the drill, however, the option of employing aids, preferably drill ejectors known to the specialist, is provided for.

### BRIEF DESCRIPTION OF THE DRAWINGS

The invention is described below based on preferred embodiments and with reference to the drawings provided:

FIG. 1 shows a prior state of the art chuck device.

FIG. 2 shows a chuck device according to an embodiment of the invention.

FIG. 3 shows the head of a turbine handpiece with a chuck device as shown in FIG. 2.

FIG. 4 shows a drill ejector for releasing an affixed tool from the chuck device shown in FIG. 3.

FIG. 5 shows a preferred, asymmetric embodiment of a clamping tab for the chuck device.

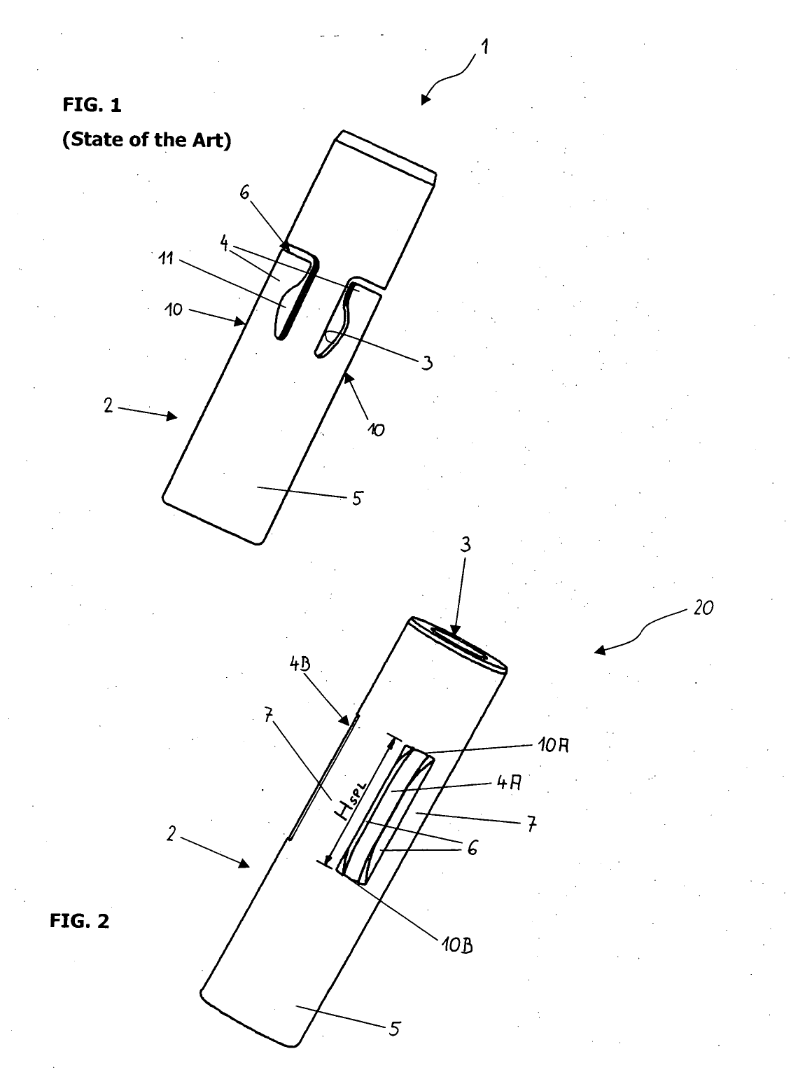

### DETAILED DESCRIPTION OF THE PREFERRED EMBODIMENTS

The same components are labelled with the same numbers in all representations.

FIG. 2 shows a chuck device 20 according to an embodiment of the invention with three equidistant clamping tabs. One of the clamping tabs is shown at 4A, and two others would be disposed at circumferentially spaced positions about spindle 2. The chuck device 20 consists of a spindle 2 with a central bore 3 for accepting a tool shaft (not represented). All three clamping tabs are produced by manufacturing two laterally spaced slots 6 each extending substantially longitudinally in the casing 5 of the spindle 2, as can be seen for clamping tab 4A, for example. Each clamping tab is immovably connected at two points of contact respectively 10A and 10B with the casing 5 of the chuck device 20. The clamping tabs are bent radially inwards, so that the clear dimension between a clamping tab 4A, bent inwards, and the opposed inner wall of the casing 5 is smaller than the diameter of a tool shaft to be received in bore 3.

Although three tabs are described for this embodiment, it should be recognized that different numbers of tabs may be used, such as from one to more than three as needed.

To the left of the clamping tab 4A a second clamping tab 4B can just be discerned. The third tab is not visible in the illustrations. Webs 7 are located between the clamping tabs and their respective slots 6. When manufacturing the chuck device 20, the width of the webs 7 and/or the clamping tabs can be varied as desired by varying the width of the slots 6 or by changing the positions at which the slots are arranged. Moreover, the wall thickness of the webs 7 and/or the clamping tabs, such as 4A, can be altered preferably by mechanical processing of the casing 5 surface, most preferably by milling. The variation of the width and/or the wall thickness of the webs 7, which govern the stability of the whole chuck device 20, and the clamping tabs 4, by which means the clamping force for the tools to be affixed is exercised, permits a precise optimization of the chuck device 20 to a variety of tools and treatment methods.

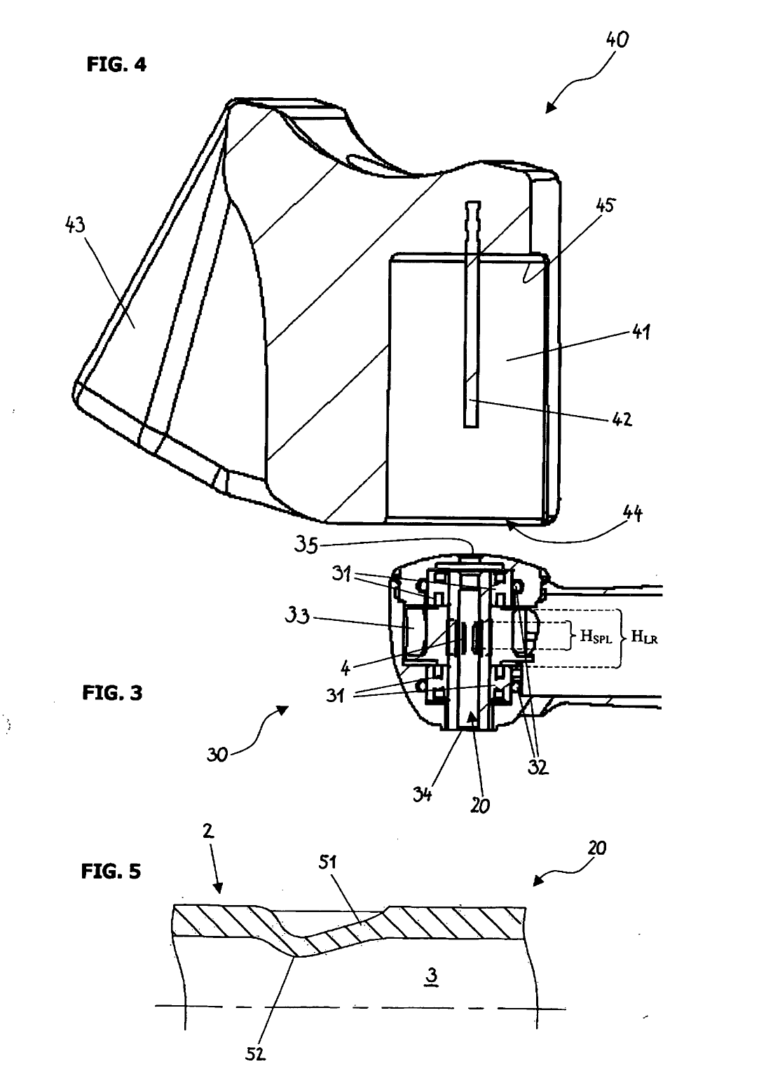

FIG. 3 shows chuck device 20 supported in two rotating bearings 31 and O-rings 32 in the head 30 of a turbine handpiece. The turbine 33 preferably is attached to the chuck device 20 by press fitting. The turbine 33 is actuated by compressed air and sets the chuck device 20 and a tool inserted through the tool carrier orifice 34 and affixed by the clamping tabs 4 in rotation. The length H_{SPL} of the clamping tabs or the slots 6 is smaller than the height H_{LR} of the turbine 33, so that the turbine 33 completely covers the clamping tabs and slots 6 and thus hinders entry of soiling and particles into the interior of the turbine handpiece.

In a preferred embodiment, in order to equally guarantee the clamping force required pursuant to EN ISO 7785-1 for the treatment instrument, and the desired spring force, as well as the wear resistance required for frequent drill changing, the clamping tab may be fabricated from a material with a tensile strength of greater than 1,000 MPa and/or a Young's modulus of 110 GPa to 220 GPa, preferably of stainless steel with a Young's modulus of 190 GPa to 220 GPa.

For ease of release of the affixed tool from the chuck device 20 a drill ejector 40, as shown in FIG. 4, may be employed. This consists of a handle body 43, preferably with a structured surface for better handling and at least one chamber 41. The dimensions of the chamber 41 are selected such that the head 30 of the turbine handpiece can be pushed through the opening 44 in the chamber 41. A pin 42 protrudes from the surface 45 opposite the chamber 41 opening 44, the diameter of which is dimensioned such that it is no larger than the clear dimension of the bore 3 in spindle 2. To release the tool the head 30 of the turbine handpiece is pushed through the opening 44 in the chamber 41, whereby the pin 42 penetrates into the bore 3 of the spindle 2 by means of an orifice 35 (FIG. 3), which is located on the side of the head 30 opposite the tool carrier orifice 34, thus driving the affixed tool out of the chuck device 20. The length of the pin 42 is preferably dimensioned such that the pin 42 completely releases the affixed tool shaft from the clamping tabs.

FIG. 5 shows an asymmetrically shaped clamping tab 51 in a sectional representation through chuck device 20. Here, the tool carrier orifice 34 (see FIG. 3), through which the tool is inserted into the chuck device 20, is positioned at the right. The clamping tab 51 is formed such that the apex 52 (i.e. the point projecting furthest into the interior of the spindle bore 3) of the curved clamping tab 51 is located in the upper half, at around approximately 2/3 of the total length of the clamping tab 51.

The invention is not restricted to the represented embodiment examples.

What is claimed is:

1. A chuck device for holding a medical treatment tool comprising
a casing having a bore for receiving a portion of said tool, and
a clamping tab coupled to said casing at at least two spaced points of contact with said casing, with a portion of said clamping tab intermediate said points of contact projecting into said bore and exercising a spring effect and clamping force to hold said portion of said tool in said bore.

2. The chuck device of claim 1, wherein said clamping tab is comprised of a material having a tensile strength greater than 1,000 MPa and a Young's modulus in a range from 110 GPa to 220 GPa.

3. The chuck device of claim 2, wherein said clamping tab is comprised of stainless steel with a Young's modulus in a range from 190 GPa to 220 GPa.

4. The chuck device of claim 1, which comprises at least two of said clamping tabs spaced apart circumferentially of said casing.

5. The chuck device of claim 1, wherein a majority of said casing has a first wall thickness and said clamping tab has a thickness less than said first wall thickness.

6. The chuck of claim 1, which comprises at least two of said clamping tabs spaced apart circumferentially of said casing with said casing having web portions between said spaced apart clamping tabs, a majority of said casing has a first wall thickness, and said clamping tabs have a thickness less than said first wall thickness.

7. The chuck device of claim 6, wherein said web portions also have a thickness less than said first wall thickness.

8. The chuck device of claim 1, wherein said chuck device is adapted to be received and held in a turbine drive of a medical treatment tool, said turbine drive having a selected height, and said clamping tab has a height less than said selected height.

9. The chuck device of claim 1, wherein said clamping tab is elongate and is formed as an integral part of said casing, with said casing having a pair of laterally spaced apart elongate longitudinally extending slots cut therethrough to release elongate longitudinally extending side margins of said clamping tab from remainder portions of said casing with opposed end portions of said clamping tab remaining attached to remainder portions of said casing, and portions of said clamping tab intermediate said opposed end portions permanently deformed so as to be bowed radially inwardly toward said bore.

10. The chuck device of claim 9, wherein said bowed configuration of said clamping tab is asymmetrical, having the apex of said bowed configuration space longitudinally from the center of said clamping tab.

11. The chuck device of claim 10, wherein said apex is positioned about ⅔ of the distance from one end of the tab toward the opposite end.

12. The chuck device of claim 1, wherein said bore extends fully through said casing and said clamping tab is disposed intermediate opposite ends of said casing, such that a tool held in said chuck by said clamping tab may be removed by a drill ejector having an elongate pin that may enter one end of said bore to engage an end of said tool and force it out of said casing.

13. The chuck device of claim 1, wherein said casing and clamping tab are elongate with said clamping tab extending longitudinally of said casing.

14. The chuck device of claim 13, wherein said clamping tab is connected to said casing at opposite ends of said clamping tab with remainder portions of said clamping tab unconnected to said casing.

15. The chuck device of claim 14, wherein portions of said clamping tab intermediate said opposite ends are deformed radially inwardly from remainder portions of said casing toward said bore.

16. A chuck device for holding a medical treatment tool comprising
an elongate casing having an axially extending bore for receiving a portion of said tool, and
an elongate clamping tab extending longitudinally of said casing and coupled to said casing at at least two spaced points of contact with said casing, with a portion of said clamping tab intermediate said points of contact projecting into said bore and exercising a spring effect and clamping force to hold said portion of said tool in said bore, said clamping tab being formed as an integral part of said casing, with said casing having a pair of laterally spaced apart elongate longitudinally extending slots cut therethrough to release elongate longitudinally extending side margins of said clamping tab from remainder portions of said casing with opposed end portions of said clamping tab remaining attached to remainder portions of said casing, and portions of said clamping tab intermediate said opposed end portions permanently deformed so as to be bowed radially inwardly toward said bore.

17. The chuck device of claim 16, wherein said clamping tab is connected to said casing at opposite ends of said clamping tab, with remainder portions of said clamping tab unconnected to said casing.

18. The chuck device of claim 17, wherein portions of said clamping tab intermediate said opposite ends are deformed radially inwardly from remainder portions of said casing toward said bore.

19. The chuck device of claim 16, wherein said bowed configuration of said clamping tab is asymmetrical, having the apex of said bowed configuration space longitudinally from the center of said clamping tab.

20. The chuck device of claim 19, wherein said apex is positioned about ⅔ of the distance from one end of the tab toward the opposite end.

21. A method for producing a chuck device for holding a medical treatment tool comprising the steps of
providing a casing having a bore extending therethrough,
forming a tab from a portion of said casing, said tab being connected to remainder portions of said casing at two spaced contact points, and deforming a portion of said tab intermediate said contact points inwardly toward said bore.

22. The method of claim 21, wherein said tab is formed by cutting two laterally spaced substantially parallel slots in a wall of said casing to produce a tab between said slots with opposite ends of said tab connected to remainder portions of said casing and side margins of said tab released from remainder portions of said casing by said slots.

23. The method of claim 22, wherein said casing is elongate and said slots extend longitudinally of said casing.

24. The method of claim 23, wherein said tab formed is elongate and extends substantially longitudinally of said casing.

25. The method of claim 22, wherein said a portion of said tab intermediate said ends us deformed inwardly of said casing toward said bore.

26. The method of claim 22, wherein the wall thickness of said tab is reduced to a thickness less than the thickness of remainder portions of the wall of said casing.

27. The method of claim 21, wherein said manufacturing process may be executed on a single machine.

28. The method of claim 21, wherein said casing and tab formed from a portion thereof are produced from a material with a tensile strength of at least 1,000 MPa.

29. The method of claim 28, wherein said casing and tab formed from a portion thereof are produced from a material having a Young's modulus in a range from 110 GPa to 220 GPa.

30. The method of claim 29, wherein said material is a stainless steel having a Young's modulus in a range from 190 GPa to 220 GPa.
